(19) United States
(12) Patent Application Publication
(10) Pub. No.: US 2002/0152294 A1
(43) Pub. Date: Oct. 17, 2002

(54) Apparatus and method for representing a class inheritance hierarchy

(76) Inventors: Stephen C. Evans, Aylesbury (GB); Karen C. Roles, Send (GB)

Correspondence Address: B. Noel Kivlin, Conley, Rose, & Tayon, P.C., P.O. Box 398, Austin, TX, 78767, US

(21) Appl. No.: 09/796,931

(22) Filed: Feb. 28, 2001

(51) Int. Cl. G06F 15/173

(52) U.S. Cl. 709/223

(57) ABSTRACT

A computer-implemented method and apparatus represents system management information for components of the system as instances of object classes within a defined inheritance hierarchy. The class inheritance hierarchy includes multiple levels below a root object class including at least a first level below the root object class and a second level below the first level. At least one first level object class at the first level forms an instance of the root class and at least one second level object class at the second level forms an instance at the first level object class. Each instance of an object class has at least one attribute with a value representing a characteristic of that instance of the object class. The method and apparatus involve populating a plurality of tables. The tables are allocated to respective object classes at the multiple levels. The tables are populated with instance entries for instances of the object classes to which the tables are allocated. The instance entries in the tables are populated with attribute entries for an attribute of the object classes. The allocation of attributes to the attribute entries is effected so as to mirror the class inheritance hierarchy. Attributes common to multiple instances of a predetermined object class are held in the table for that object class. This approach is applied throughout the object hierarchy. The root class is represented in a Management Information Base (MIB) table with the classes at lower levels in the hierarchy being represented by respective extension tables. The extension tables are sparsely populated enabling the representation of the hierarchy with MIB extension tables spread across an appropriate number of MIBs to accommodate the classes required.

### BACKGROUND OF THE INVENTION

This invention relates to the representation of classes within a defined class inheritance hierarchy.

A collection of resources or components within a system can typically be represented as a hierarchy of objects. Such a representation can be helpful for management, for example for remote management of part or all of the system.

The Simple Network Management Protocol (SNMP) provides a means for monitoring and managing systems remotely via a network. The definition of SNMP can be found in RFC2578 at http://wvvw.ietforg/rfc/rfc2578.txt. Nodes of a system managed under SNMP have an associated SNMP agent that interfaces with a management interface at the node via the SNMP protocol and exposes portions of the node's management interfaces to SNMP managers on the network. The representation of this information is defined in a Management Information Base (MIB) specified using a notation known as the Structure of Management Information, the definition of version 2 of which is also to be found at http://www. ietf.or /rfc/rfc2578.txt.

The system/devices that are represented by the MIB are viewed as a collection of managed objects, each of which may be said to be of a given object class. The attributes of multiple instances of such a class are generally represented within the MIB using SNMP tables.

The Telecommunications Management Network (TNM) network management model defines a class hierarchy of such managed object classes. However, SNMP does not provide a mechanism for presenting instances of classes from within such an inheritance hierarchy. SNMP tables do not provide a structure whereby the hierarchical relationships can be represented. A consequential disadvantage of this is that the conventional tabular approach of SNMP provides for only limited extensibility, and the structure of the tables is inflexible. Accordingly, the aim of the invention is to provide a table-based representation of representation of classes within a defined class inheritance hierarchy that is flexible and extensible.

### SUMMARY OF THE INVENTION

A first aspect of the invention provides a computer-implemented mechanism that represents system management information for components of a system as instances of object classes within a defined class inheritance hierarchy. The class inheritance hierarchy includes multiple levels below a root object class including at least a first level below the root object class and a second level below the first level. At least one first level object class at the first level forms an instance of the root class and at least one second level object class at the second level forms an instance of the first level object class. Each instance of an object class has at least one attribute with a value representing a characteristic of that instance of an object class. The mechanism comprises a plurality of tables. The tables are allocated to respective object classes at the multiple levels. The tables have instance entries for instances of the object classes to which said tables are allocated. Also, the instance entries in the tables have attribute entries for attributes of the object classes. The mirroring of the hierarchy is obtained by allocating of attributes to attribute entries so as to mirror the class inheritance hierarchy, with attributes common to multiple instances of a predetermined object class being held in the table for that object class.

The distribution of the attributes with the grouping of attributes common to object classes enables an efficient representation of the object class hierarchy. For example if it is desired to inspect a particular attribute for a set of managed objects that form instances of a given object class, then this can be achieved by access to the common table for that object class. It is not necessary to access the respective tables for the objects themselves. Not only is this more efficient in that it is not necessary to look in all the separate tables for the objects concerned, but it also means that an application that carries out the inspection will not need to know how to interpret all of the attribute types for all of the managed objects, but will only need to be able to understand the common attributes at the level of the object class mentioned above.

In an embodiment of the invention, a root class table is provided that has instance entries for instances of the root object class and the instance entries having attribute entries for attributes of the instances of the root object class. The provision of the root class provides a highest level of the hierarchy of objects of interest and provides a root node from which the hierarchy is defined.

In representing the hierarchy, an object class at a given level in the inheritance hierarchy can include attributes for object classes at multiple lower levels in the hierarchy.

In a preferred example of the invention, instances of a root object class are held in respective entries in an MIB table, instances of second level object classes that are subclasses of the instances of the root object class are held in corresponding entries in at least one first MIB extension table and instances of third level object classes that are subclasses of the instances of the first level object classes are held in corresponding entries in at least one second MIB extension table. In particular, the instance entries are defined in respective rows of the MIB table and MIB extension tables.

Each attribute has an attribute type and an attribute value. In the preferred example of the invention, respective attribute types are allocated to respective columns in the tables. In particular, each attribute type is allocated to a predetermined column in one of the MIB tables and MIB extension tables, the attribute value of a given attribute type for a given instance of an object class being held in the row for that instance of the object class.

In the preferred example of the invention, the MIB extension tables can be sparsely populated for representing the inheritance hierarchy as will be come clear from the specific example described hereinafter.

The “MIB extension tables” may be spread across a number of MIBs. This means that an existing class, represented using one or more MIBs may be sub-classed by the addition of a further MIB to provide the table extension definitions for the sub-classe's additional attributes. This provides facilitates extensibility.

As described above, the mechanism can be operable to enable inspection of a table allocated to an object class at a given level in the hierarchy of at least a predetermined attribute for object classes at multiple levels in the hierarchy below that given level.

Also, the mechanism can be operable to enable access of a table allocated to an object class at a given level below the root object class in the hierarchy for at least a predetermined attribute for an object class at a level in the hierarchy below that given level.

The mechanism can further be operable to display a representation of the class inheritance hierarchy, the mechanism being operable to display the attributes for a given instance of an object class with the display of attributes for a given instance of an object class being grouped according to the table in which the attributes are held.

Another aspect of the invention provides a computer program for implementing the above-mentioned mechanism. A further aspect of the invention provides a data structure on a carrier medium for implementing the above-mentioned mechanism. The invention also provides a computer system comprising a storage medium containing such a data structure.

The invention further provides a computer-implemented method of representing system management information for components of a system as instances of object classes within a defined class inheritance hierarchy. The method comprising populating a plurality of tables, including steps of:

allocating said tables to respective object classes at said multiple levels;

populating said tables with instance entries for instances of the object classes to which said tables are allocated; and

populating said instance entries in said tables with attribute entries for attributes of the object classes, the allocation of attributes to attribute entries being effected so as to mirror the class inheritance hierarchy with attributes common to multiple instances of a predetermined object class being held in the table for that object class.

Further aspects and advantages of the invention will become apparent from the following description of a preferred embodiment.

### BRIEF DESCRIPTION OF THE DRAWINGS

Exemplary embodiments of the present invention will be described hereinafter, by way of example only, with reference to the accompanying drawings in which like reference signs relate to like elements and in which:

FIG. 1 is a schematic representation of a network environment;

FIG. 2 is a schematic block diagram illustrating a managed device;

FIG. 3 is a schematic block diagram representing a management station;

FIG. 4 is a schematic exploded representation of one possible example of a managed device;

FIG. 5 illustrates the derivation of Object Identifiers (OIDs);

FIG. 6 represents a hardware resource class inheritance diagram;

FIG. 7 represents a supported subset of ITU-T GNIM classes;

FIG. 8 represents a hardware resource hierarchy;

FIG. 9 represents a physical entity table;

FIG. 10 represents a physical mapping table;

FIG. 11 represents Network-Information-Model Managed information base NIM) extension tables;

FIG. 12 represents NIM Extension tables (NEM);

FIG. 13 represents a hardware resource inheritance class diagram;

FIG. 14 represents steps in a process of generating a table representation of class inheritance;

FIG. 15 is a schematic representation of a screenshot displaying a class inheritance diagram and of attributes associated with a selected object; and

FIG. 16 is a flow diagram illustrating the obtaining of the attribute information for the display of FIG. 15.

### DESCRIPTION OF PARTICULAR EMBODIMENTS

Exemplary embodiments of the present invention are described in the following with reference to the accompanying drawings.

Although particular embodiments of the invention have been described, it will be appreciated that many modifications/additions and/or substitutions may be made within the spirit and scope of the invention as defined in the appended claims.

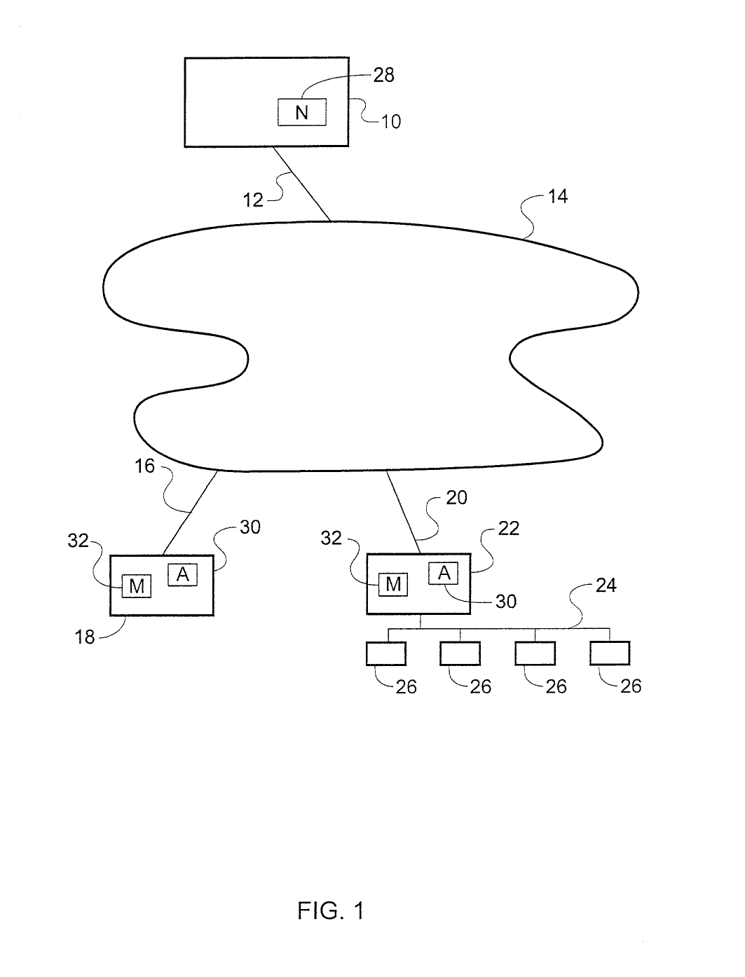

An embodiment of the invention provides an apparatus and method of providing effective remote management of the components of a network connected system or device. FIG. 1 is a schematic representation of an environment in which an embodiment of the present invention could be implemented.

FIG. 1 shows a management station 10 that includes a management controller (N) 28, for example configured in software, for managing one or more devices via a connection 12 to a network 14. The network 14 could be the internet, an intranet, or any other form of network. As represented in FIG. 1, a device 18 is connected to that network via a connection 16. The device 18 includes an agent (A) 30 that is responsive to a request for data representing the state of the device 18 and/or for receiving instructions from the management controller 28 for controlling the device 18. In order to be able to control the device 18, information (M) about the device 18 is stored in a memory 32. Also shown in FIG. 1 is a further device 22, which also includes an agent (A) 30 and data memory (M) 32. The device 22 is connected to the network 14 via further connection 20. The device 22 is a server for controlling one or more further devices 26 via a local network 24. In this case, the data memory 32 can include data about the status of the internal network 24 and each of the devices 26 as well as the device 22.

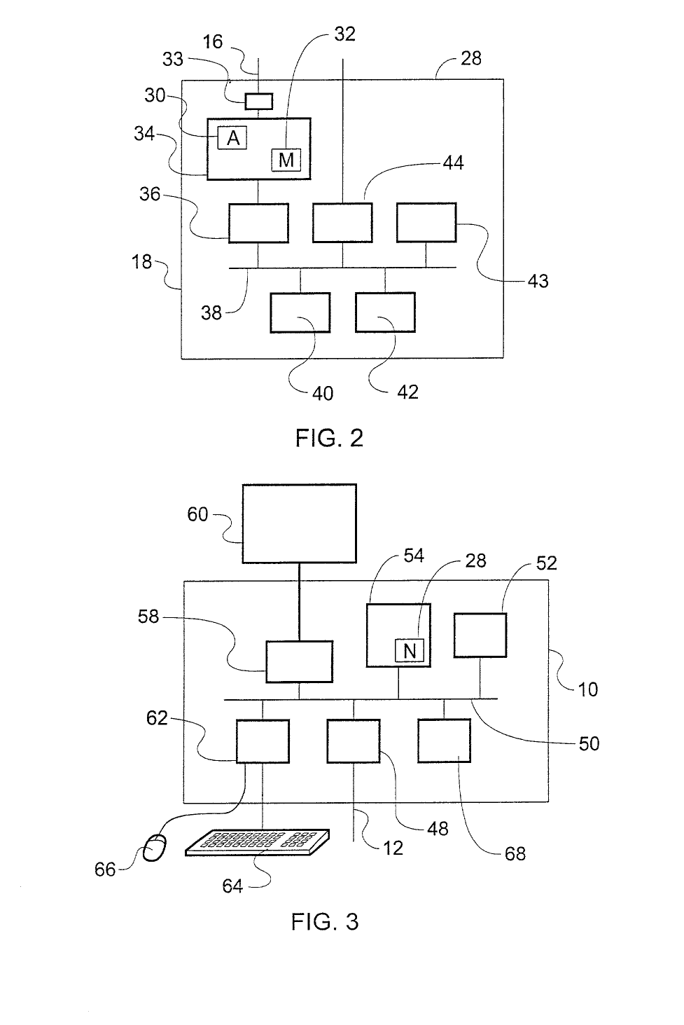

FIG. 2 is a schematic representation of a managed device 18. In the particular instance shown, the managed device 18 is a server computer. The server computer 18 is provided with a service processor 34 that implements the agent 30 and the data memory 32. In a preferred embodiment of the invention, the service processor is implemented using a microcontroller. The service processor 34 is connected by a bus bridge 36 to a bus 38 for interconnecting the service processor with the main system processor (or processors) of the server 18. Also connected to the bus 38, as shown schematically in FIG. 2, is main memory 42, further storage 43, and an interface 44 to a further connection 28 to the network 14.

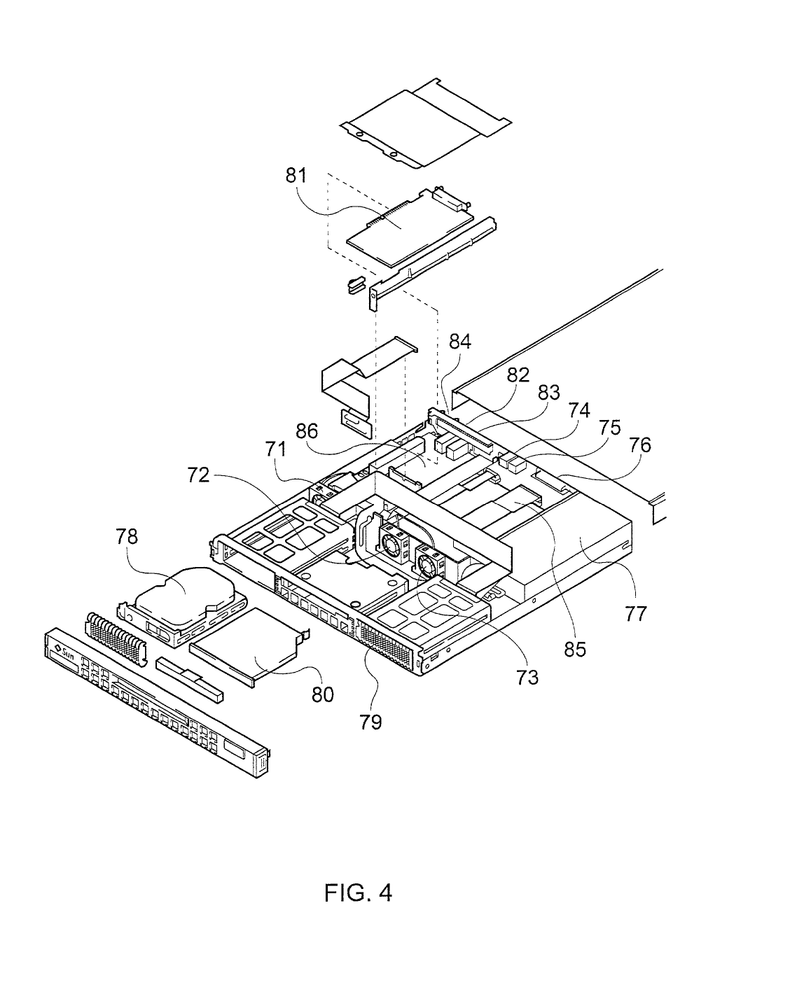

It will be appreciated that FIG. 2 is only a schematic overview of a server computer. Indeed, the device 18 can take many different forms. One example only, of a possible managed device is represented in FIG. 4. This shows an exploded view of a thin format server and illustrates various components of that server. The various components highlighted in FIG. 4 are first, second and third fans, 71, 72 and 73, first and second serial ports 74 and 75, a Small Computer Serial Interface (SCSI) connector 76, a power supply unit 77, first and second disk drives 78 and 79, a CD-ROM 80, a Peripheral Computer Interconnect (PCI) card 81, first and second net connections 82 and 83, fault LEDs 84, a SCSI adapter card 85 and the motherboard 86.

FIG. 3 is a schematic overview of a possible configuration of the server station 10. This can also be implemented as a server. It will be appreciated that FIG. 3 merely gives a schematic overview of some of the components of that server station 10. As shown in FIG. 3, the connection 12 to the network 14 is connected via an interface 48 to an internal bus 50 within the server 10. Connected to the server 10 is a processor 52 and memory 54 that contains a software component (N) 28 for implementing the management controller referenced in FIG. 1. A display adapter 58 connects a display 60 to the bus 50, and an input adapter 62 connects one or more input devices such as a keyboard 64 and a pointing device 66. Also shown in FIG. 3 is mass storage 68, which will typically be implemented as a hard disk. The system 10 of FIG. 3 could be implemented as any conventional computer system connectable to a network via a network interface. The management controller 28 is implemented by software in the present instance, but it could be implemented by means, for example, by special purpose hardware e.g. an Application Specific Integrated Circuit (ASIC).

The preferred embodiment of the invention is intended to operate under the Simple Network Management Protocol (SNMP), although other embodiments of the invention could be configured to operate under other protocols. There follows a brief description of the principles of SNMP.

The Simple Network Management Protocol (SNMP) is an open internet standard for management of networked devices (systems). It is defined, in line with other internet standards, by a number of RFCs. There are two versions of SNMP of interest here, SNMPv1, RFC1157/STD 15 (see http://www.ietf.org/rfc/rfc1157.txt) being the root document from which the other related RFCs are referenced, and SNMPv2 (a superset of SNMPv1) which is defined by a supplementary set of RFCs, the most significant being RFC2578 (see http://www.ietf.org/rfc/rfc2578.txt). Further information about SNMP can be found in the above referenced standards.

SNMP is a network protocol which allows devices to be managed remotely by a management controller termed a Network Management Station (NMS) 28. In order to be managed, a device must have an SNMP Agent 30 associated with it. The Agent 30 is responsible for receiving requests for data representing the state of the device from the NMS and providing an appropriate response. The Agent 30 can also accept data from the NMS 28 in order to allow control of the state of the device. Additionally, the Agent can generate SNMP Traps, which are unsolicited messages sent to selected NMS(s) to signal significant events relating to the device. In order to manage/monitor devices their characteristics must be represented using some format known to both the Agent 30 and the NMS 28. These characteristics can represent physical properties such as fan speeds, or services such as routing tables. The data structure defining these characteristics is known as a Management Information Base (MIB) and corresponds to the data memory (M) 32 of FIGS. 1 to 3. This data model is typically organized into tables, but can also include simple values. An example of the former is routing tables, and an example of the latter is a timestamp indicating the time at which the agent was started.

The MIB is defined using a language called ASN. 1. For reference, the structure of the MIBs for SNMPv2 is defined by its Structure of Management Information (SMI) defined in RFC2578 (see http://www.ietf.org/rfc/rfc2578.txt). This defines the syntax and basic data types available to MIBs. The Textual Conventions (type definitions) defined in RFC2579 (see http://www.ietf.org/rfc/rfc2579.txt) define additional data types and enumerations.

In order for an NMS 28 to manage a device via its Agent 30, the MIB 32 corresponding to the data presented by the Agent 30 must be loaded into the NMS 28. The mechanism for doing this varies depending on the implementation of the network management software. This gives the NMS 28 the information required to address and correctly interpret the data model presented by the Agent 30. Note that MIBs 32 can reference definitions in other MIBs 32 so in order to use a given MIB 32, it may be necessary to load others.

The MIB 32 is a definition for a virtual datastore accessible via SNMP, the content being provided either by corresponding data maintained by the Agent 30, or by the Agent 30 obtaining the required data on demand from the managed device. For writes of data by the NMS 28 to this virtual data, the Agent 30 will typically perform some action affecting the state either of itself or the managed device. In order to address the content of this virtual datastore the MIB 32 is defined in terms of Object Identifiers (OIDs) which uniquely identify each data entry. An OID consists of a hierarchically arranged sequence of integers, providing a unique name space. Each assigned integer has an associated text name. For example, the OID 1.3.6.1 corresponds to the OID name iso.org.dod.internet and 1.3.6.1.4 corresponds to the OID name iso.org.dod.internet.private. The numeric form is used within SNMP protocol transactions, whereas the text form is used in user interfaces to aid readability. Objects represented by such OIDs are commonly referred to by the last component of their name as a shorthand form. In order to avoid confusion arising from this convention, it is normal to apply an MIB-specific prefix, such as sunNim, to all object names defined therein.

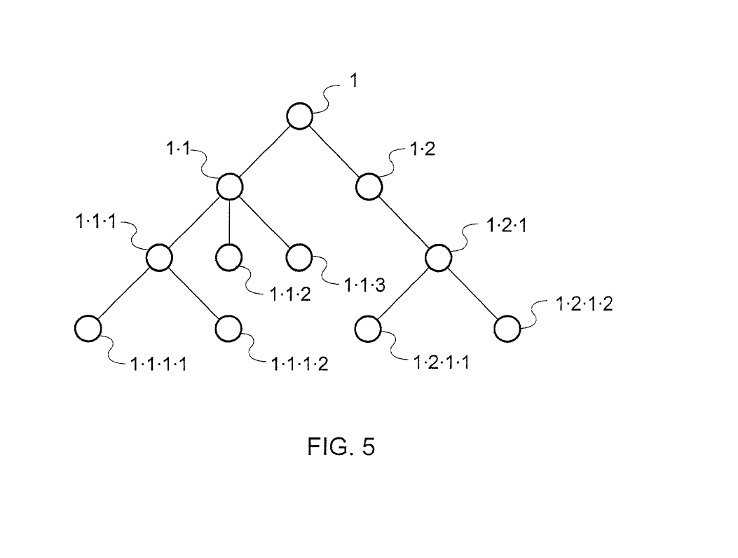

FIG. 5 is a schematic representation of the principle under which an OID is generated. It can be seen that it is generated according to a tree structure where each of the nodes at the various levels in the tree are given respective additional address integers separated by dots.

All addressable objects defined in the MIB have associated maximum access rights, for instance, read-only or read-write, which determine what operations the NMS 28 will permit the operator to attempt. The Agent 30 is able to apply lower access rights as required, that is, it is able to refuse writes to objects which are considered read-write. This refusal may be done on the grounds of applicability of the operation to the object being addressed, or on the basis of security restrictions which can limit certain operations to restricted sets of NMS. The mechanism used to communicate security access rights is that of community strings. These are simply text strings such as ‘private’and ‘public’that are passed with each SNMP data request.

Much of the data content defined by MIBs 32 is of a tabular form, organized as entries consisting of a sequence of objects (each with their own OIDs). For example, a table of fan characteristics could consist of a number of rows, one per fan, with each row containing columns corresponding to the current speed, the expected speed, and the minimum acceptable speed. The addressing of the rows within the table can be a simple single dimensional index (a row number within the table, for instance ‘6’). or a more complex, multi-dimensional, instance specifier such as an IP address and port number (for instance 127.0.0.1, 1234). In either case a specific data item within a table is addressed by specifying the OID giving its prefix (for instance myFanTable.myFanEntry.myCurrentFanSpeed) with a suffix instance specifier (for instance 127.0.0.1.1234 from the previous example) to give myFanTable.myFanEntry.myCurrentFanSpeed. 127.0.0.1.1234.

Each table definition within the MIB 32 has an INDEX clause that defines which instance specifier(s) to use to select a given entry. The INDEX clause defining the MIB syntax provides an important capability whereby tables can be extended to add additional entries, effectively adding extra columns to the table. This is achieved by defining a table with an INDEX clause that is a duplicate of that of the table being extended.

An NMS 28 communicates with the Agent 30 by sending (UDP) packets to a well known port (e.g., a port 33 illustrated in FIG. 2) on the system on which the agent is running. Should there be many Agents 30 running on a given system, each managing different devices, there is a potential conflict for the use of the port resource. One possible solution is to use different, non-standard, port numbers for each Agent 30. An alternative is to introduce the concept of a Master Agent that accepts SNMP requests on behalf of all the Agents 30 running on a given system and forwards these requests as appropriate. This has the benefit of allowing an NMS to access all SNMP Agents 30 in a consistent manner. The concept of a Master Agent could be applied, for example in the case of the Agent 30 of the device 22 shown in FIG. 1, with “slave Agents” being provided in each of the devices 26 connected via the local network to the device 22.

Although the present invention works within the Simple Network Management Protocol, it extends the concepts employed in conventional SNMP environments to enable a more efficient representation of the managed resources of the managed resources. An embodiment of the invention presents the managed device as a collection of nested resources within a Chassis. Some resources may be nested directly within the Chassis, such as a motherboard, or a network connector. Other devices may be nested within other resources, for example a motherboard may include a processor or a drive may hold a disk. These relationships extended from the Chassis form a hierarchy of hardware resources. This hierarchy is modeled using relationships between managed objects representing the resources.

An embodiment of the invention employs a set of common platform building blocks representing fundamental hardware resources. These platform building blocks are called “managed objects”. A hardware resource will be represented by a managed object if it can be monitored or provide useful configuration information.

Additional managed objects are used to represent other features of the management interface; for example, hardware resources can issue asynchronous status reports, called notifications, in response to problems or changes in configuration.

Managed objects are defined in terms of “managed object classes”. Characteristics of a resource are represented by “attributes” of the managed object. New classes, called subclasses, are defined in terms of existing classes. A subclass inherits all the characteristics of its superclass, but represents its own characteristics by adding new attributes and notifications.

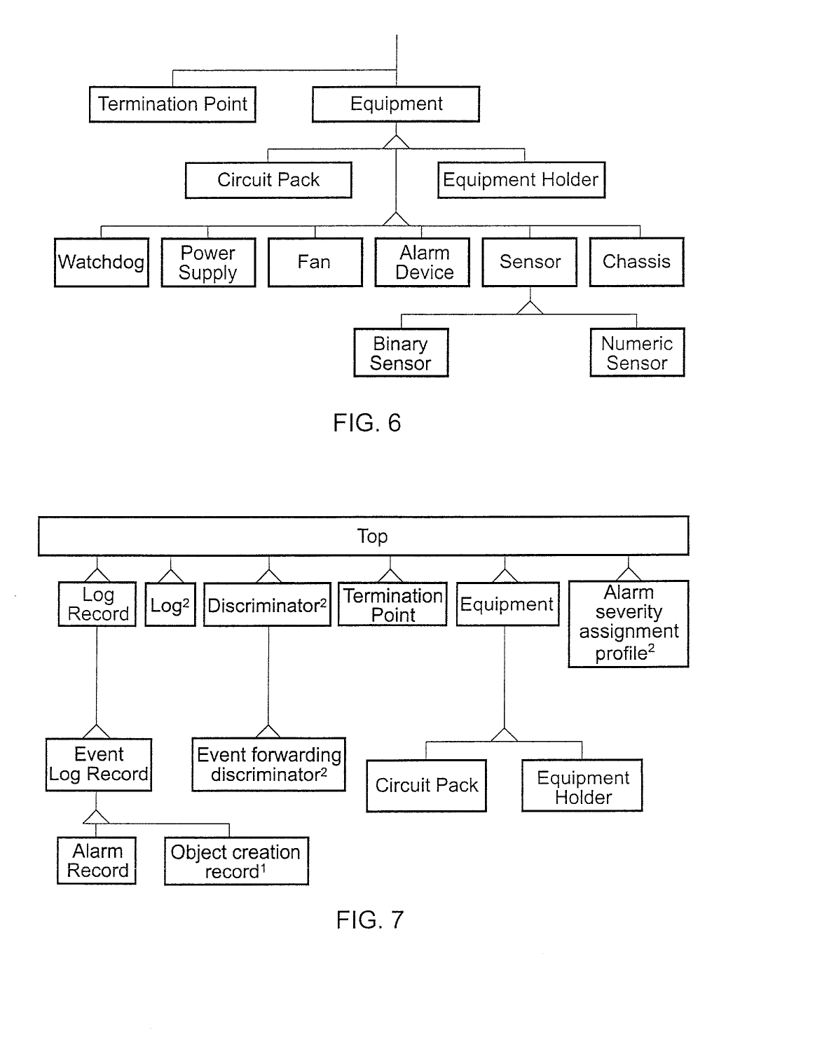

FIG. 6 illustrates a resource class inheritance diagram for hardware components of a managed device. FIG. 6 illustrates the class names for various building blocks defined within an embodiment of the invention and illustrates the relationship between them. Thus, for example, with the exception of the termination point, all of the various components are instances of the equipment class. Also, the Binary and Numeric Sensors are instances of the class of sensor.

The classes employed in the preferred embodiment of the invention are based on industry-standard management concepts and use a subset of the ITU-T Generic Network Information Model (GNIM). The GNIM provides a powerful and extendable framework that supports uniform fault and configuration management in a Telecommunications Management Network (TMN).

The Agents 30 use a subset of the ITU-T GNIM as represented in FIG. 7. The ITU-T GNIM has been specialized through inheritance to provide managed object classes that represents characteristics of different types of resources. The preferred example of the invention extends the GNIM equipment class using the so-called Distributed Management Task Force Common Interface Model (DMTF CIMv2) concepts. An embodiment of the present invention includes a novel representation of the managed objects and their relationships. This unique relationship is based on the conventional MIB representations, but uses these representations in a new way to mirror the class inheritance hierarchy represented in FIG. 6. The Agent 30 of a preferred embodiment of the invention uses three SNMP MIBs to represent the managed objects of the device to which the agent is allocated. These SNMP MIBs include the so-called Entity-MIB (defined in RFC2737), a Network-Information-Model MIB (termed herein NIM), and a NIM-extension MIB (termed herein NEM).

The Entity-MIB is defined by the IETS standard RFC2737 (see http://www.ietf.org/rfc/2737/text). The Entity-MIB provides a hierarchy of the hardware resources and indicates the relationship between managed objects. It also provides common hardware resource characteristics, including a mapping of common attributes from the GNIM top, equipment and termination point classes. Table extensions can be generated in the manner described in RFC2578, Section 7.7 and 7.8 (see http://www.ietf.org/rfc/rfc2578.txt) as “additional columns” that logically extend a conceptual row.

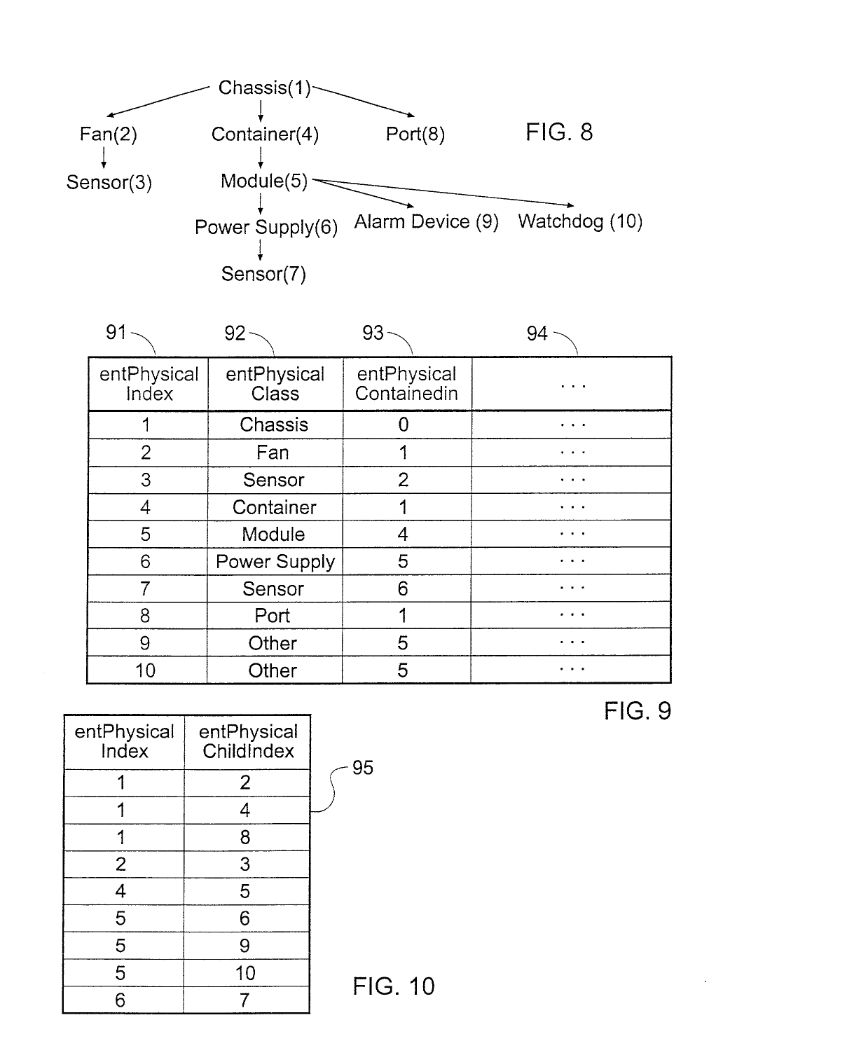

FIGS. 8, 9 and 10 show how an example of the hierarchy of hardware resources is presented using the Entity-MIB. FIG. 8 shows how different indexes (1)-(10) are allocated to the various hardware resources that may be provided within the Chassis, either directly, or within other resources. FIGS. 9 and 10 illustrate two of three SNMP tables that form part of the Entity-MIB. These are the Physical Entity Table shown in FIG. 9, the Physical Mapping Table shown in FIG. 10 and a General Table that is not shown in the drawings. These three tables will be summarized in the following:

Physical Entity Table 90 (entPhysicalTable)

This table, as illustrated in FIG. 9, provides a row per hardware resource. These rows are called Entries and a particular row is referred to as an instance. Each entry contains the physical class (entPhysicalClass) 92 and common characteristics of the hardware resource. Each entry has a unique index (entPhysicalIndex) 91 and contains a reference (entPhysicalContainedIn) 93 which points to the row of the hardware resource which acts as the container for this resource, as well as further information 94.

Physical Mapping Table 95 (entPhysicalContainsTable)

This table, as illustrated in FIG. 10, provides a virtual copy of the hierarchy of the hardware resources represented in the Physical Entity Table. This table is two-dimensional, indexed firstly by the entPhysicalIndex 91 of the containing entry, and secondly by the entPhysicalIndexes of the contained entries.

General Table (entGeneralTable)

This table (not shown) provides the time interval between the agent starting and the last change to the Physical Entity Table or Physical Mapping Table.

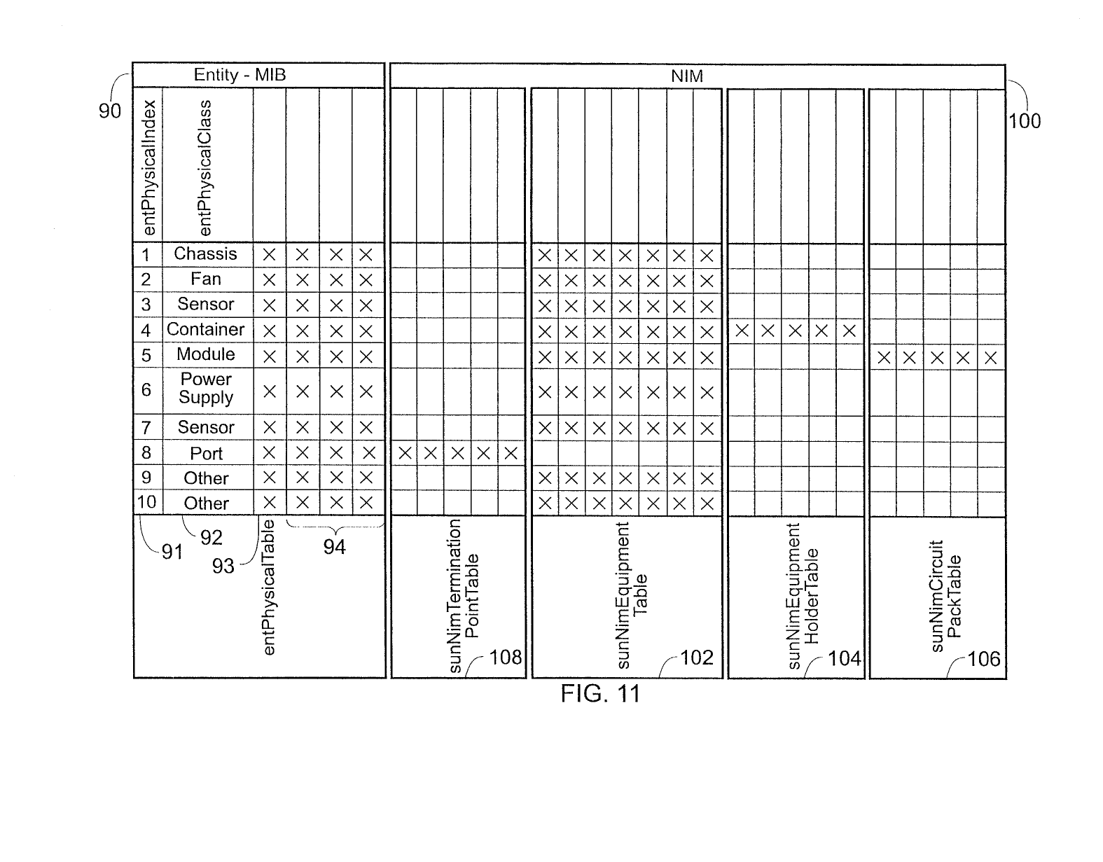

The Network-Information-Model MIB (NIM) provides the additional attributes from the GNIM classes that are not represented in the Physical Entity Table. The NIM extends the Physical Entity Table by adding four sparsely populated Table Extensions as illustrated in FIG. 11.

Equipment Table Extension 102 (sunNimEquipmentTable)

This extends the Physical Entity Table to provide further information for managed objects of the GNIM Equipment class. This class is applicable for all hardware resources with the exception of communication ports. Subclasses of the GNIM Equipment class are represented by further Table Extensions.

Equipment Holder Table Extension (104) (sunNimEquipmentHolderTable)

This augments the GNIM Equipment Table Extension. It provides the additional information relevant for managed objects of the GNIM Equipment Holder class.

Circuit Pack Table Extension 106 (sunNimCircuitPackTable)

This augments the GNIM Equipment Table Extension. It provides the additional information relevant for managed objects of the GNIM Circuit Pack class.

Termination Point Table Extension (108) (sunNimTerminationPointTable)

This extends the Physical Entity Table to provide further information for managed objects of the GNIM Termination Point class.

The various tables shown in FIG. 11 are only populated as required. Thus, for example, in a particular example shown in FIG. 11, the populated entries in the table are marked with a cross, whereas the non-populated entries are shown empty.

Each of the columns in the table shown in FIG. 11 is allocated to an individual attribute type. In each row, attribute values are provided for those various attribute types where the table is indicated as populated.

Although not shown in FIG. 11, the NIM also defines the event records for the GNIM notifications. These records form part of the payload of the SunNim SNMP trap notifications. The record data that accompanies an SNMP trap is as follows:

Object Creation Record (sunNimObjectCreation)

This indicates that a hardware resource has been added to the hierarchy.

Object Deletion Record (sunNimObjectDeletion)

This indicates that a hardware resource has been removed from the hierarchy.

Communications Alarm Record (sunNimCommunicationsAlarm)

This indicates that a failure has occurred in the communication services that the hardware resource supports.

Environmental Alarm Record (sunNimEnvironmentalAlarm)

This indicates an environmental condition relating to the hardware resource.

Equipment Alarm Record (sunNimEquipmentAlarm)

This indicates that a hardware resource has become faulty.

Processing Error Alarm Record (sunNimProcessingErrorAlarm)

This indicates that a hardware resource has an associated software or processing fault.

State Change Record (sunNimStateChange)

This indicates that the state of the hardware resource has changed.

Integer Attribute Value Change Record (sunNimAttributeChangeInteger)

This indicates a change in a characteristic of a hardware resource modeled by an attribute of type Integer.

String Attribute Value Change Record (sunNimAttributeChangeString)

This indicates a change in a characteristic of a hardware resource modeled by an attribute of type String.

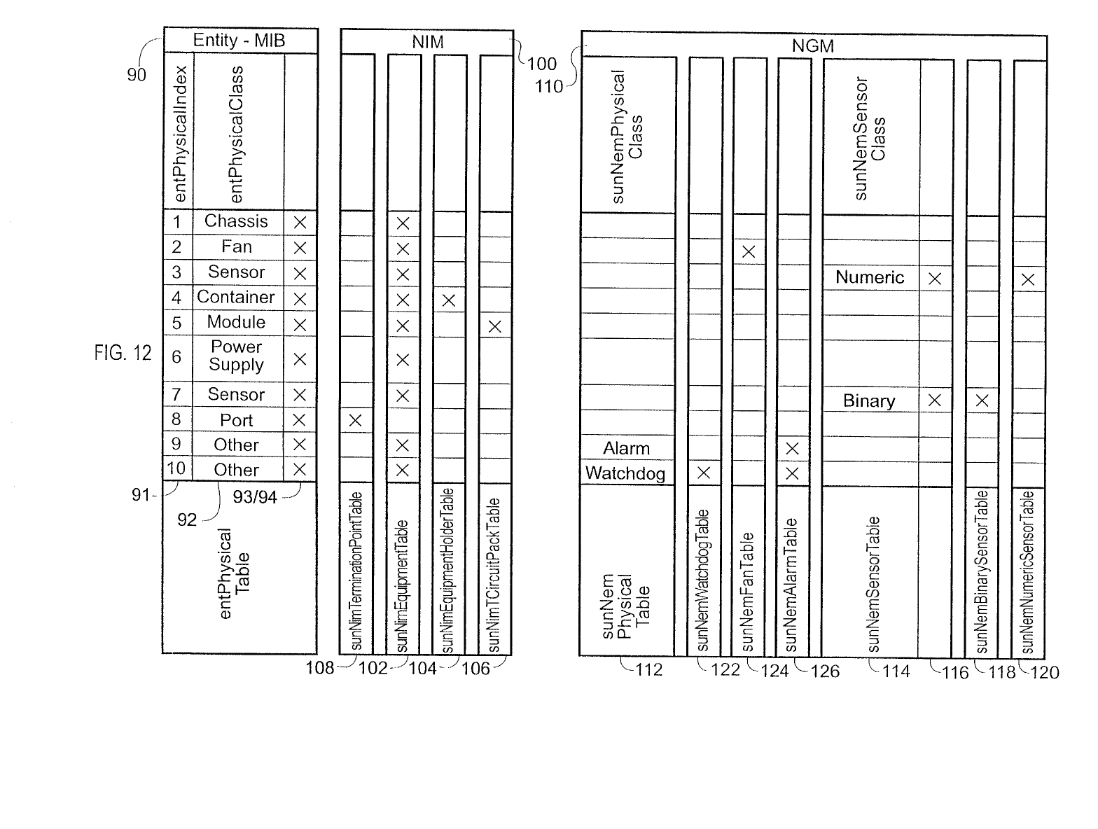

FIG. 12 illustrates the NIM extension MIB (NEM) 110 and its relationship to the Entity-MIB 90 and the NIM 100. It is to be noted that the Entity MIB 90 and the NIM 100 have been compressed in order to be able to illustrate the NEM 110 in the same drawing.

The NEM 110 provides the attributes of the DMTF-derived subclasses of the GNIM Equipment class.

The NEM 110 further extends the Physical Entity Table 90 by the addition of seven sparsely populated Table Extensions. Note that the Power Supply and Chassis subclasses do not extend the characteristics of the GNIM Equipment class. and as such do not have their own Table Extensions.

Physical Table Extension 112 (sunNemPhysicalTable)

This extends the Physical Entity Table. It is used to supplement the entPhysicalClass column in the Physical Entity Table. If a hardware resource has an entPhysicalClass of ‘other’, but is of a class modeled by the SunNem, that is, the Watchdog or Alarm Device class, this table will identify its SunNem class.

Sensor Table Extension 114 (sunNemSensorTable)

This augments the Equipment Table Extension. It provides the additional information 116 relevant for managed objects of the Sensor class. Subclasses of Sensor class are represented by further Table Extensions.

Binary Sensor Table Extensions 118 (sunNemBinarySensorTable)

This augments the Sensor Table Extension. It provides additional information relevant for managed objects of the Binary Sensor class.

Numeric Sensor Table Extension 120 (sunNemNumericSensorTable)

This augments the Sensor Table Extension. It provides additional information 122 relevant for managed objects of the Numeric Sensor class.

Fan Table Extension 122 (sunNemFanTable)

This augments the Equipment Table Extension. It provides the additional information relevant for managed objects of the Fan class.

Alarm Table Extension 124 (sunNemAlarmTable)

This augments the Equipment Table Extension. It provides the additional information relevant for managed objects of the Sensor class.

Watchdog Table Extension 126 (sunNemWatchdogTable)

This augments the Equipment Table Extension. It provides the additional information relevant for managed objects of the Watchdog class.

The sparsely populated table structure shown in FIGS. 9-11, and in particular in FIG. 11, extends the principles of the SNMP table structure in a way which has not been used before to be able to represent the class inheritance hierarchy of resources within a device.

The “MIB extension tables” can be spread across a number of MIBs. This means that an existing class, represented using one or more MIBs may be sub-classed by the addition of a further MIB to provide the table extension definitions for the sub-classe's additional attributes. This provides facilitates extensibility.

Here it should be noted that the class inheritance hierarchy as illustrated in FIG. 6 is not to be confused with the hardware resource hierarchy illustrated in FIG. 8. The hardware resource hierarchy illustrated in FIG. 8 can be represented by the Entity-MIB 90 as has already been described. However, the conventional Entity-MIB structure is not able to represent the inheritance class hierarchy illustrated in FIG. 6.

FIG. 12 illustrates the manner in which the inheritance hierarchy of NIM classes is used to model hardware resources within a product. The various elements within FIG. 12 will now be described in more detail.

The Physical Entity superclass 130 provides an attribute for defining the relationship between managed objects. It also provides standard SNMP attributes that correspond to GNIM attributes in the Top. Termination Point and Equipment class 131.

The classes NIM Termination Point 132 and NIM Equipment 134 are subclassed from Physical Entity to provide the additional attributes (133 and 135, respectively) defined in the corresponding GNIM classes.

The NIM Equipment class 134 is subclassed to provide the NIM Equipment Holder class 136 and NIM Circuit Pack class 138, each providing further attributes 137 and 139 respectively.

The NIM Equipment class 134 is then further specialized to provide the DMTF-derived classes for NEM Watchdog 140, NEM fan 142, NEM Alarm device 144, and NEM Sensor class 146, each with respective further attributes 141, 143, 145 and 147. The NEM Sensor class 146 is further subclassed into a NEM Numeric Sensor class 148 and a NEM Binary Sensor class 150 each with respective further attributes 149 and 151. The classes NEM Power Supply 152 and NEM Chassis 154 are defined to complete the alignment of SunNIM to standard SNMP classes or hardware resources.

The NEM subclass of NIM Equipment provides attributes specific to the hardware resource that is applicable for fault monitoring.

The Physical Entity superclass 130 is used to represent the characteristics that are generic to all hardware resources. These generic characteristics are represented by attributes 131. These can include a description attribute that has as its value a text string containing the known name for the hardware resource. An Is FRU attribute has, as its value, a Boolean representing whether the hardware resource is a field replaceable unit. A hardware revision attribute has, as its value, a text string containing manufacturer's hardware revision information. A name attribute has as its value a text string containing a logical name by which the hardware resource is known to the operating system and associated utilities. A model name attribute has, as its value, a text string containing the manufacturer's customer visible part number or part definition. A serial number attribute has, as its value, a text string containing the manufacturer's serial number for the resource. A manufacturer's name attribute has, as its attribute, a text string containing the manufacturer's name for the hardware resource. The Physical Entity superclass also contains attributes used for describing the hierarchy of the resources. This includes a class attribute, which has, as its value, an indication of the general hardware type of a particular physical resource. The supportive values of this class are defined by the Entity-MIB 90. This attribute can be used as an indication of the relevant table extensions for the managed object. The mapping between the Entity-MIB classes and the NIM classes in shown in Table 1 below.

TABLE 1

| Entity Class | SunNim Class |
|---|---|
| Chassis | NEM Chassis |
| Backplane | NIM Equipment |
| Container | NIM Equipment Holder |
| Power Supply | NEM Power Supply |
| Fan | NEM Fan |
| Sensor | NEM Sensor, plus subclasses |
| Module | NIM Circuit Pack |
| Port | NIM Termination Point |
| Stack | Not Implemented |
| Other | NIM Equipment, plus subclasses |
| Unknown | Not Implemented |

An index attribute has, as its value, an integer that uniquely identifies the entry in the Physical Entity table that identifies the managed object. A contained in attribute has, as its value, an entity representing the index attribute of the managed object containing this managed object. This models a relationship between the managed objects.

The attributes of the NIM classes are used to represent characteristics of the hardware resources. The availability and operability of the resource to the manager are represented by the state of the managed object. Different NIM classes have a variety of attributes that express aspects of the managed objects state.

The NIM Equipment class 134 is used to represent the characteristics that are generic to all hardware resources, with the exception of ports. This class contains attributes representing configuration and generic health status information. This class is further subclassed to provide more detailed configuration information and monitoring data for particular types of hardware resource.

The NIM Equipment 134 class has a number of attributes 135, each of which will be held in a respective column within the NIM Equipment table 102. A location name attribute has, as its value, a text string containing a locator for the hardware resource. For resources contained directly within the Chassis, this attribute would correlate with legends on slots and product document, or provide a geographical indication of the position of the hardware resource within the Chassis. Other hardware resources will typically have a location corresponding to the description of the managed object for the hardware resource in which it is contained. An unknown status attribute has as its value an indication whether other state attributes may possibly not reflect the true state of the hardware resource. This is a Boolean representing whether the managed object is able accurately to report faults against the hardware resource. In the present embodiment, if the hardware resource is unable truthfully to reflect its state, the attribute will be set to true. An operation state attribute has as its value an enumerated type representing whether the hardware resource is physically installed and capable of providing service. This attribute contributes to the state of the managed object.

A NIM Circuit Pack class 136 includes attributes 137 for representing characteristics generic to a replaceable hardware resource or FRU. It includes a type attribute, which has as its value a text string for assessing the hardware resources compatibility with its container, and an availability status attribute, which has as its value a set of enumerated types further qualifying the operational state of the managed object. These attributes will be held in appropriate columns within the NIM Circuit Pack Table 106.

A NIM Equipment Holder class 138 includes attributes 139 for representing characteristics of hardware resources that are capable of holding removable hardware resources. The NIM Equipment Holder class 138 has as attributes 139 a type attribute which has as its value an enumerated type representing the holder type of the hardware resource, a status attribute, which has as its value an enumerated type indicating the status of the holder with regard to any replaceable hardware resource it may contain, and an acceptable Circuit Pack type, which has as its value a list of text strings representing the types of removable hardware resources acceptable to the holder. These attributes will be held in respective columns of the Equipment Holder Table 104.

A NIM Termination Point class 132 is used to represent characteristics of communication ports and has, as its attributes 133, an operational state attribute with a value indicating an enumerated type representing whether the port is providing required physical activity, and an unknown status attribute, which has as its value a Boolean representing whether the managed object is able accurately to report faults against the port. These attributes will be held in respective columns of the Termination Point Table 108.

The NEM Power Supply class 152 is used to represent a power supply. It does not extend the characteristics of the NIM Equipment Class. A power supply typically contains sensors representing monitored properties, for example voltages, current, and temperature. It can also contain other hardware resources such as fans. This is modeled using relationships between the managed objects. If a power supply is a removable hardware resource, it will be modeled within a managed object of the NIM Circuit Pack class 136.

A NEM Watchdog class 140 is used to represent characteristics of timer hardware resources that allow the hardware to monitor the state of the operating system or applications. The NEM Watchdog class 140 has attributes 141 including an action attribute that is an enumerated type representing the action taken by the Watchdog within a period specified by the value of a timeout attribute. The timeout attribute has as its value an indicator indicating the interval in microseconds after which the Watchdog will not timeout if reset. These attributes will be held in respective columns of the NEM Watchdog Table 122.

The NEM Alarm Device class 144 is used to represent characteristics of hardware resources that emit indications relating to problem situations, for example buzzers, LEDs, relays, vibrators, and software alarms. The NEM Alarm Device class has attributes 145 including a type attribute that has as its value an enumerated type representing the means by which the alarm is communicated and a state attribute that has as its value an enumerated type representing the state of the alarm. These attributes will be held in respective columns of the NEM Alarm Table 126.

The NEM Fan class 142 is used to represent the characteristics of active cooling fans. A fan typically contains a sensor representing a speed of rotation. This is modeled using a relationship between the NEM Fan managed object and the managed object of the class NEM Binary Sensor or NEM Numeric Sensor. The NEM Fan class 142 has a variable speed attribute 143 with a value that is a Boolean representing whether the fan supports variable speeds. This attribute will be held in a column in the NEM Fan Table 124.

The NEM Sensor class 146 is a superclass that represents the generic characteristics of hardware resources that measure properties of other hardware resources. The NEM Sensor class 146 has as attributes 147 a type attribute with a value that is an enumerated type identifying the property that the sensor measures and a latency attribute which has as its value an integer representing a polling update interval measured in microseconds. Where the sensor is event-driven, the value represents the maximum expected latency in processing that event. These attributes are held in respective columns in the NEM Sensor table 114.

A NEM Binary Sensor class 150 is used to represent the characteristics of sensors that return binary output. The NEM Binary Sensor class has as attributes 151 an interpret true attribute with a value that has a text string indicating the interpretation of a true value from the sensor, an interpret false attribute that has as its value a text string indicating the interpretation of a false value from the sensor, an expected attribute that has as its value a Boolean indicating the anticipated value of the sensor and a current attribute that has as its value a Boolean indicating the most recent value of the sensor. These attributes are held in respective columns within the NEM Binan, Sensor table 118.

The NEM Numeric Sensor class 148 is used to represent the characteristics of sensors that can return numeric readings. The NEM Numeric Sensor class 148 has as attributes 149 an accuracy attribute that has a value that is an integer indicating the degree of error of the sensor for the measured property, a normal min attribute that has as its value an integer indicating the defined threshold below which the sensor reading is not expected to fall, a normal max attribute that has as its value an integer indicating the defined threshold above which the sensor reading is not expected to rise, an exponent attribute that has as its value an integer used to scale a base unit attribute by a power of 10, and a base unit attribute that has as its value an enumerated type indicating the unit of measurement which can be, for example, deg C, volts, amperes, revolutions. A rate units attribute which has as its value an enumerated type indicating whether the sensor is measuring absolute value or a rate and a current attribute that has as its value an integer indicating the most recent value of the sensor. These attributes are held in respective columns within the NEM Numeric Sensor table 120.

A NEM Chassis class 154 is used to represent the primary enclosure for the modeled product. It does not extend the characteristics of the NIM Equipment class. The Chassis contains all the modeled hardware resources, and is not contained within any other hardware resource.

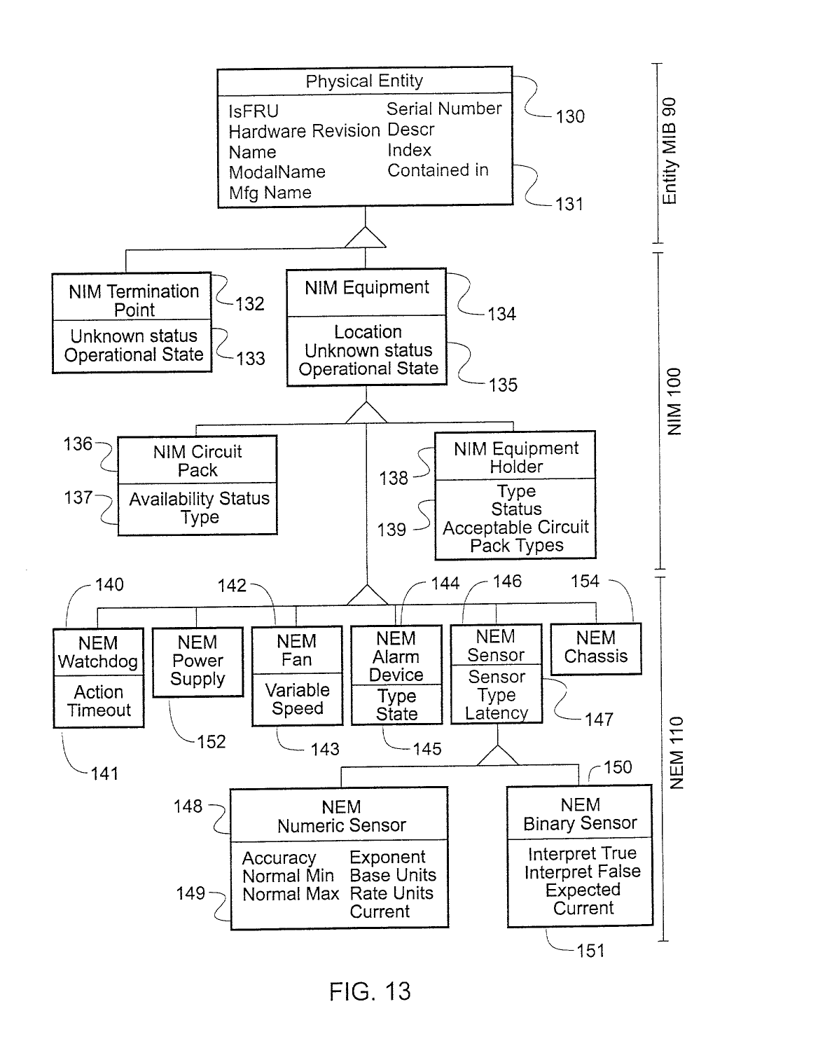

Accordingly, there has been described a table-based solution to the representation of instances of classes within a defined class inheritance hierarchy using SNMP tables. An embodiment of the invention enables the following approach to representing an instance of a class and the defined class inheritance hierarchy as illustrated in FIG. 13.

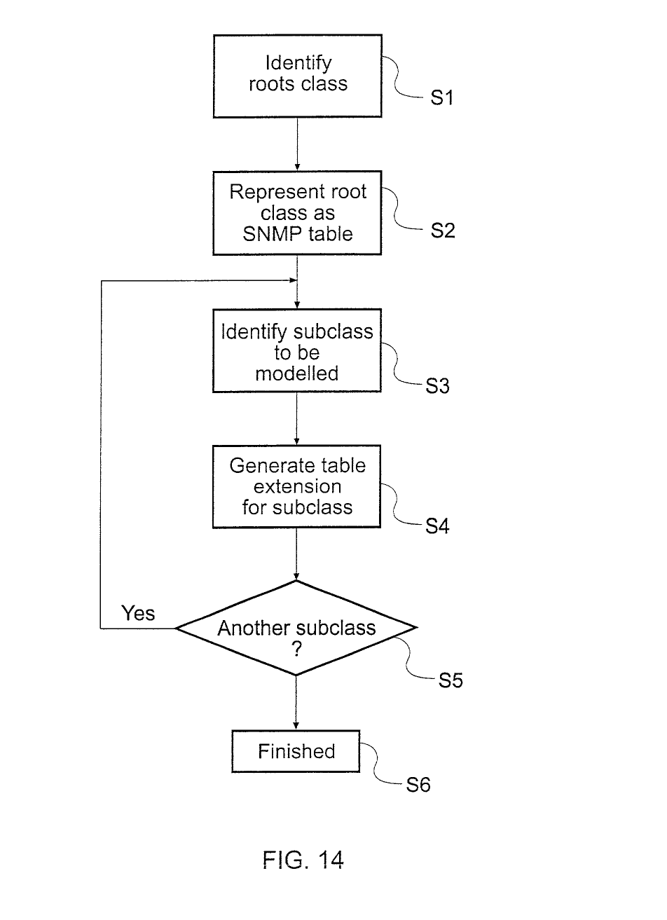

FIG. 14 is a flow diagram illustrating the representation of instances of classes within a defined class inheritance hierarchy.

In Step 1, the class of the root (or apex) of the class inheritance hierarchy is identified.

In Step 2, this class is represented in a SNMP table, with one row per instance, the columns of the table being assigned to represent the attributes of the (root) class.

In Step 3, each sub-class of the root class that is to be modeled is identified within the SNMP MIB.

In Step 4, for each sub-class, additional table extensions are defined. The table extensions described with reference to FIGS. 11-13 above, logically extend a conceptual row and are used to represent the additional attributes with each class extending its superclass. Each row of the original SNMP table, representing the root class, is thus extended to represent the attribute of its sub-classes as required. New duplication of attributes is hence required as would be the case were the class to be represented in a discreet table.

This technique allows an existing MIB, defined as above, to be complemented with further MIBs as required to represent further sub-classes of the classes it defines. This technique may also be applied to existing MIBs such as the Entity-MIB as described above to model sub-classes of existing discreet managed object classes.

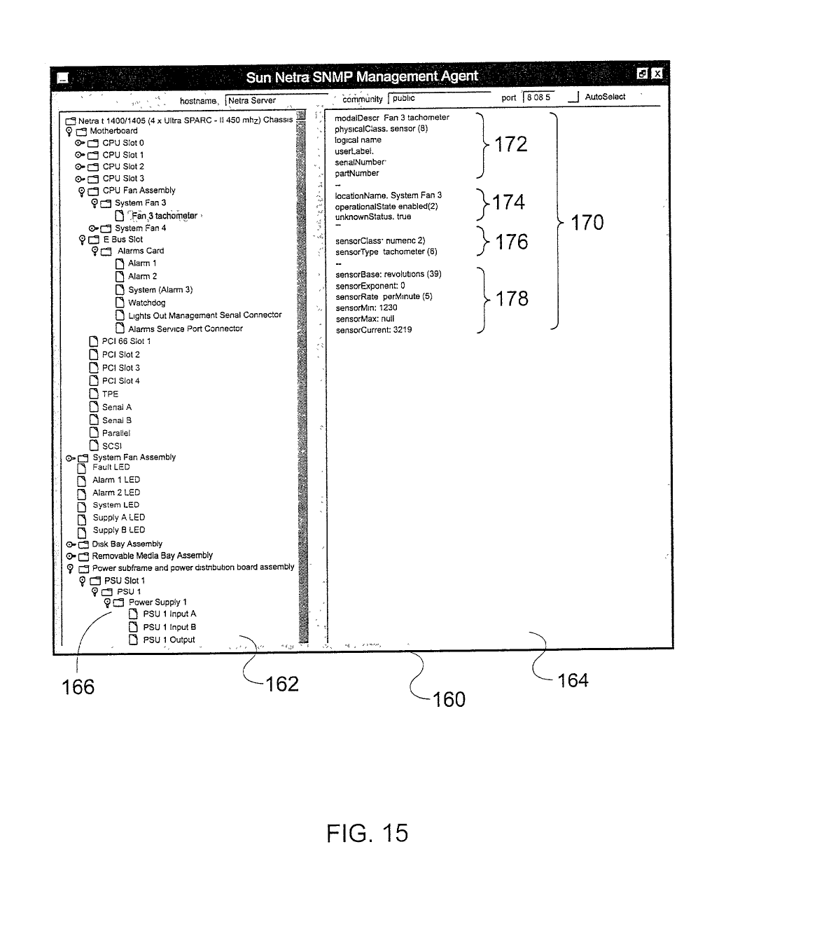

FIG. 15 is a schematic representation of a screenshot showing the display of attributes for a selected class that can be displayed on the display 60 of the management station 10 shown in FIG. 3.

FIG. 15 shows a screenshot 160 that has a left-hand window 162 containing a graphical representation of the inheritance class hierarchy 166 with a particular object in that class hierarchy highlighted at 168. The object can be highlighted in a conventional manner by navigating through the hierarchy using pointer operations and selecting (by double clicking on a mouse button) at the selected object 168. A right-hand window 164 illustrates the status of the attributes for the selected object. The presentation of the attributes 170 is split into groups 172-178 based on the levels within the class hierarchy at which the individual attributes are held.

Those attributes that are generic to the highest, or root class, are shown at 172. The attributes that are held at a first level below the root class level in the class hierarchy are displayed at 174. The attributes that are present at a second level below the root level are shown at 176. The attributes that are present at a third level below the root level are shown at 178. This presentation provides a consistent and readily understandable presentation of the attributes of the various managed objects. Thus, for example, each object will always have attributes corresponding to those shown at the root level 172. Accordingly, the attribute types will not change in the area 172, although the attribute values will change depending on the particular device selected.

The individual attribute types at the second level 174 will depend on the first level object class below the root object. If the object selected is a first level object below the root class, then only attributes in sections 172 and 174 will be displayed.

If the object selected is at a third level in the class hierarchy, information will be displayed at 172, 174 and 176. The attributes displayed at 174 are dependent on the object class at the first level below the root class that forms the superclass of the object class selected at the second level below the root class. The information displayed at 176 will depend on the class of the object selected at the second level below the root object.

If the object selected is at a fourth level in the class hierarchy, information will be displayed at 172, 174, 176 and 178. The attributes displayed at 174 are dependent on the object class at the first level below the root class that forms the superclass of the object class at the second level below the root class that in turn forms the superclass of the object class selected at the third class below the root class. The attributes displayed at 176 are dependent on the object class at the second level below the root class that forms the superclass of the object class selected at the third level below the root class. The information displayed at 178 will depend on the class of the object selected at the third level below the root object.

It will be appreciated that the invention can be extended to further levels of hierarchy, and is readily extensible through the use of the sparsely populated extension tables, with the MIB extension tables spread across a appropriate number of MIBs to accommodate the classes required.

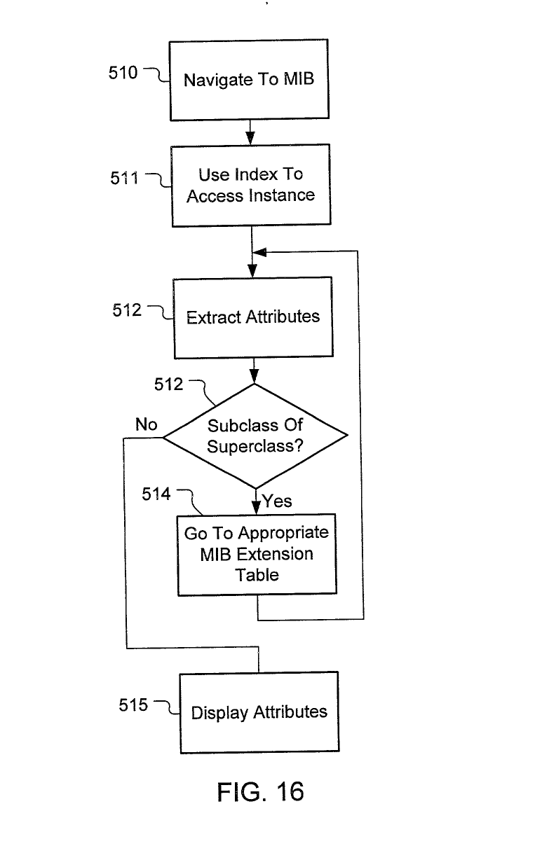

FIG. 16 is a flow diagram illustrating the steps in inspecting the attributes of a selected object class for display.

In Step 10, the management controller (NMS) 28 navigates to the MIB for the device to be managed. As indicated earlier, this can be achieved by the management controller sending UDP packets to the agent running on the device to be controlled, whereby the agent then interrogates the MIB. The management controller 28 indicates the index for accessing the MIB instance in Step 11.

In Step 12, the Agent 30 extracts the attributes from the respective columns of the MIB entry selected by the index.

In Step 13, the Agent 30 identifies whether the selected class is a sub-class of a superclass (on the first pass the superclass being the root represented by the MIB table).

If the selected class is a sub-class of the current class, then, in Step 14, the Agent 30 accesses the appropriate MIB extension table for that sub-class. Then, in Step 12, the Agent 30 extracts the attributes from the corresponding entry (row) of the MIB extension table.

The sequence of Step 12, Step 13 and Step 14 is repeated in a recursive manner until it is determined in Step 13 that the class currently under investigation is the class of the object for which information has been requested by the management controller 28. At this time, the extraction of the attributes is complete, and these can then be displayed at Step 15 on the display of the management station 10.

The transmission of the individual attributes could be performed by the Agent 30 once all attributes relating to the selected object have been extracted i.e. at Step 15. This would reduce the network traffic. However, as an alternative, the attributes could be supplied to the management controller 28 as they are extracted i.e. in Step 12.

The attributes, when received by the management controller 28, are stored in the memory 54 of the management station 10, and can be displayed in the manner described with reference to FIG. 15.

Although a particular embodiment of the invention has been described, it will be appreciated that many modifications and additions are possible within the spirit and scope of the invention. Accordingly, the particularly described embodiment is not intended to be limiting, but merely provides an example of a possible implementation.

For example, as described above. the Agent 30 is implemented in a microcontroller forming part of a service processor 34. However, the Agent 30 could be implemented by a software component held in main memory of the device to be managed, the software component causing the main system processor or processors 40 of the managed device to provide the appropriate functionality described above.

Such a software component can be provided as a program product on a carrier medium. The carrier medium could be a storage medium such as an optical, magneto optical or magnetic disk, a tape, a solid state memory, or indeed any other form of storage medium. It could also be a transmission medium such as a telephone wire, a wireless communication medium such as a radio or microwave transmission medium, or indeed any other form of transmission medium.

Similarly, the management controller 28 could be implemented as software and could be supplied on a carrier medium wherein the carrier medium can be any carrier medium as described above. Alternatively, the management controller 28 could be implemented by means of microcode or special purpose logic and implemented in a device such as, for example, an application specific integrated circuit (ASIC).

Also, in the present example, the storage of the data structure including the plural tables is held in the device to be managed and is accessed directly by the management controller 28 when information regarding the resources in the device to be managed is required. However, as an alternative, those tables could be held outside the device to be managed, or could be copied, for example, at regular intervals, to the management controller 28, or to an alternative location separate from the managed device and the management controller. Such an example may be desirable where a reliable link to the managed device is not possible and/or characteristics thereof are likely to change at infrequent intervals. The MIB extension tables can be spread across a number of MIBs to accommodate the classes required. Thus, an existing class, represented using one or more MIBs may be sub-classed by the addition of a further MIB to provide the table extension definitions for the sub-classe's additional attributes.

1. A computer-implemented mechanism that represents system management information for components of a system as instances of object classes within a defined class inheritance hierarchy, wherein
the class inheritance hierarchy includes multiple levels below a root object class including at least a first level below the root object class and a second level below the first level, with at least one first level object class at the first level forming an instance of the root class and at least one second level object class at the second level forming an instance of the first level object class and
each instance of an object class has at least one attribute with a value representing a characteristic of that instance of an object class.
the mechanism comprising a plurality of tables, wherein:
said tables are allocated to respective object classes at said multiple levels; said tables have instance entries for instances of the object classes to which said tables are allocated; and
instance entries in said tables have attribute entries for attributes of the object classes, the allocation of attributes to attribute entries being effected so as to mirror the class inheritance hierarchy with attributes common to multiple instances of a predetermined object class being held in the table for that object class.

2. The computer-implemented mechanism of claim 1, further including a root class table, said root class table having instance entries for instances of the root object class and the instance entries having attribute entries for attributes of the instances of the root object class.

3. The computer-implemented mechanism of claim 2, wherein at least one table for an object class at a given level in the inheritance hierarchy includes attributes for object classes at multiple lower levels in the hierarchy.

4. The computer-implemented mechanism of claim 3, wherein instances of the root object class are held in respective entries in a MIB table, instances of second level object classes that are subclasses of the instances of the root object class are held in corresponding entries in at least one first MIB extension table and instances of third level object classes that are subclasses of the instances of the first level object classes are held in corresponding entries in at least one second MIB extension table.

5. The computer-implemented mechanism of claim 4, wherein instances of the root object class are held in respective rows in a MIB table, instances of second level object classes that are subclasses of the instances of the root object class are held in corresponding rows in at least one first MIB extension table and instances of third level object classes that are subclasses of the instances of the first level object classes are held in corresponding rows in at least one second MIB extension table.

6. The computer-implemented mechanism of claim 5, wherein each attribute has an attribute type and an attribute value, each MIB table and MIB extension table comprising at least one column, each attribute type being allocated to a predetermined column in one of the MIB tables and MIB extension tables, the attribute value of a given attribute type for a given instance of an object class being held in the row for that instance of the object class.

7. The computer-implemented mechanism of claim 4, wherein at least one of the MIB extension tables is sparsely populated.

8. The computer-implemented mechanism of claim 1, wherein the MIB extension tables are spread across a plurality of MIBs tables.

9. The computer-implemented mechanism of claim 1, wherein the mechanism is operable to enable inspection of a table allocated to an object class at a given level in the hierarchy of at least a predetermined attribute for object classes at multiple levels in the hierarchy below that given level.

10. The computer-implemented mechanism of claim 1, wherein the mechanism is operable to enable access of a table allocated to an object class at a given level below the root object class in the hierarchy for at least a predetermined attribute for an object class at a level in the hierarchy below that given level.

11. The computer-implemented mechanism of claim 10, operable to display a representation of the class inheritance hierarchy, the mechanism being operable to display the attributes for given instance of an object class with the display of attributes for given instance of an object class being grouped according to the table in which the attributes are held.

12. A computer program on a carrier, the computer program comprising program instructions operable to represent management information for components of a system as instances of object classes within a defined class inheritance hierarchy, wherein
the class inheritance hierarchy includes multiple levels below a root object class including at least a first level below the root object class and a second level below the first level, with at least one first level object class at the first level forming an instance of the root class and at least one second level object class at the second level forming an instance of the first level object class and
each instance of an object class has at least one attribute with a value representing a characteristic of that instance of an object class.
the computer program comprising program instructions operable to define a plurality of tables, wherein:
said tables are allocated to respective object classes at said multiple levels; said tables have instance entries for instances of the object classes to which said tables are allocated; and
instance entries in said tables have attribute entries for attributes of the object classes, the allocation of attributes to attribute entries being effected so as to mirror the class inheritance hierarchy with attributes common to multiple instances of a predetermined object class being held in the table for that object class.

13. The computer program of claim 12, wherein the program instructions are operable to enable inspection of a table allocated to an object class at a given level in the hierarchy of at least a predetermined attribute for object classes at multiple levels in the hierarchy below that given level.

14. The computer program of claim 12, wherein the program instructions are operable to enable access of a table allocated to an object class at a given level below the root object class in the hierarchy for at least a predetermined attribute for an object class at a level in the hierarchy below that given level.

15. The computer program of claim 13, wherein the program instructions are operable to display a representation of the class inheritance hierarchy, the mechanism being operable to display the attributes for given instance of an object class with the display of attributes for a given instance of an object class being grouped according to the table in which the attributes are held.

16. A data structure on a carrier medium that represents system management information for components of a system as instances of object classes within a defined class inheritance hierarchy, wherein
the class inheritance hierarchy includes multiple levels below a root object class including at least a first level below the root object class and a second level below the first level, with at least one first level object class at the first level forming an instance of the root class and at least one second level object class at the second level forming an instance of the first level object class and
each instance of an object class has at least one attribute with a value representing a characteristic of that instance of an object class,
the data structure comprising a plurality of tables, wherein:
said tables are allocated to respective object classes at said multiple levels; said tables have instance entries for instances of the object classes to which said tables are allocated; and
instance entries in said tables have attribute entries for attributes of the object classes, the allocation of attributes to attribute entries being effected so as to mirror the class inheritance hierarchy with attributes common to multiple instances of a predetermined object class being held in the table for that object class.

17. The data structure of claim 16, further including a root class table, said root class table having instance entries for instances of the root object class and the instance entries having attribute entries for attributes of the instances of the root object class.

18. The data structure of claim 17, wherein at least one table for an object class at a given level in the inheritance hierarchy includes attributes for object classes at multiple lower levels in the hierarchy.

19. The data structure of claim 18, wherein instances of the root object class are held in respective entries in an MIB table, instances of second level object classes that are subclasses of the instances of the root object class are held in corresponding entries in at least one first MIB extension table and instances of third level object classes that are subclasses of the instances of the first level object classes are held in corresponding entries in at least one second MIB extension table.

20. The data structure of claim 16, wherein instances of the root object class are held in respective rows in an MIB table, instances of second level object classes that are subclasses of the instances of the root object class are held in corresponding rows in at least one first MIB extension table and instances of third level object classes that are subclasses of the instances of the first level object classes are held in corresponding rows in at least one second MIB extension table.

21. The data structure of claim 20, wherein each attribute has an attribute type and an attribute value, each MIB table and MIB extension table comprising at least one column, each attribute type being allocated to a predetermined column in one of the MIB tables and MIB extension tables, the attribute value of a given attribute type for a given instance of an object class being held in the row for that instance of the object class.

22. The data structure of claim 21, wherein at least one of the MIB extension tables is sparsely populated.

23. The data structure of claim 22, wherein the MIB extension tables are spread across a plurality of MIBs tables.

24. A computer system comprising a storage medium containing a data structure that represents system management information for components of a system as instances of object classes within a defined class inheritance hierarchy, wherein
the class inheritance hierarchy includes multiple levels below a root object class including at least a first level below the root object class and a second level below the first level, with at least one first level object class at the first level forming an instance of the root class and at least one second level object class at the second level forming an instance of the first level object class and
each instance of an object class has at least one attribute with a value representing a characteristic of that instance of an object class,
the data structure comprising a plurality of tables, wherein:
said tables are allocated to respective object classes at said multiple levels; said tables have instance entries for instances of the object classes to which said tables are allocated; and
instance entries in said tables have attribute entries for attributes of the object classes, the allocation of attributes to attribute entries being effected so as to mirror the class inheritance hierarchy with attributes common to multiple instances of a predetermined object class being held in the table for that object class.

25. The computer system of claim 24, further including a root class table, said root class table having instance entries for instances of the root object class and the instance entries having attribute entries for attributes of the instances of the root object class.

26. The computer system of claim 25, wherein at least one table for an object class at a given level in the inheritance hierarchy includes attributes for object classes at multiple lower levels in the hierarchy.

27. The computer system of claim 26, wherein instances of the root object class are held in respective entries in an MIB table, instances of second level object classes that are subclasses of the instances of the root object class are held in corresponding entries in at least one first MIB extension table and instances of third level object classes that are subclasses of the instances of the first level object classes are held in corresponding entries in at least one second MIB extension table.

28. The computer system of claim 27, wherein instances of the root object class are held in respective rows in an MIB table, instances of second level object classes that are subclasses of the instances of the root object class are held in corresponding rows in at least one first MIB extension table and instances of third level object classes that are subclasses of the instances of the first level object classes are held in corresponding rows in at least one second MIB extension table.

29. The computer system of claim 28, wherein each attribute has an attribute type and an attribute value, each MIB table and MIB extension table comprising at least one column, each attribute type being allocated to a predetermined column in one of the MIB table and MIB extension tables, the attribute value of a given attribute type for a given instance of an object class being held in the row for that instance of the object class.

30. The computer system of claim 29, wherein at least one of the MIB extension tables is sparsely populated.

31. The computer system of claim 30, wherein the MIB extension tables are spread across a plurality of MIBs tables.

32. The computer system of claim 24, comprising a processor and program code operable to enable inspection of a table allocated to an object class at a given level in the hierarchy of at least a predetermined attribute for object classes at multiple levels in the hierarchy below that given level.

33. The computer system of claim 32, wherein the program code is operable to enable access of a table allocated to an object class at a given level below the root object class in the hierarchy for at least a predetermined attribute for an object class at a level in the hierarchy below that given level.

34. The computer system of claim 33 further comprising a display, wherein the program code is operable to display a representation of the class inheritance hierarchy, the mechanism being operable to display the attributes for a given instance of an object class with the display of attributes for a given instance of an object class being grouped according to the table in which the attributes are held.

35. A computer-implemented method of representing system management information for components of a system as instances of object classes within a defined class inheritance hierarchy, wherein
the class inheritance hierarchy includes multiple levels below a root object class including at least a first level below the root object class and a second level below the first level, with at least one first level object class at the first level forming an instance of the root class and at least one second level object class at the second level forming an instance of the first level object class and
each instance of an object class has at least one attribute with a value representing a characteristic of that instance of an object class,
the method comprising populating a plurality of tables, including:
allocating said tables to respective object classes at said multiple levels;
populating said tables with instance entries for instances of the object classes to which said tables are allocated; and
populating said instance entries in said tables with attribute entries for attributes of the object classes, the allocation of attributes to attribute entries being effected so as to mirror the class inheritance hierarchy with attributes common to multiple instances of a predetermined object class being held in the table for that object class.

36. The computer-implemented method of claim 35, further including populating a root class table, said root class table having instance entries for instances of the root object class and the instance entries having attribute entries for attributes of the instances of the root object class.

37. The computer-implemented method of claim 36, further including populating at least one table for an object class at a given level in the inheritance hierarchy with attributes for object classes at multiple lower levels in the hierarchy.

38. The computer-implemented method of claim 37, further including holding instances of the root object class in respective entries in an MIB table, instances of second level object classes that are subclasses of the instances of the root object class in corresponding entries in at least one first MIB extension table and instances of third level object classes that are subclasses of the instances of the first level object classes in corresponding entries in at least one second MIB extension table.

39. The computer-implemented method of claim 38, further including holding instances of the root object class are held in respective rows in an MIB table, instances of second level object classes that are subclasses of the instances of the root object class in corresponding rows in at least one first MIB extension table and instances of third level object classes that are subclasses of the instances of the first level object classes in corresponding rows in at least one second MIB extension table.

40. The computer-implemented method of claim 39, wherein each attribute has an attribute type and an attribute value, each MIB table and MIB extension table comprising at least one column, the method including allocating each attribute type to a predetermined column in one of the MIB tables and MIB extension tables and holding the attribute value of a given attribute type for a given instance of an object class being the row for that instance of the object class.

41. The computer-implemented method of claim 40, including sparsely populating at least one of the MIB extension tables.

42. The computer-implemented method of claim 35, wherein the MIB extension tables are spread across a plurality of MIBs tables.

43. The computer-implemented method of claim 35, further comprising inspecting a table allocated to an object class at a given level in the hierarchy of at least a predetermined attribute for object classes at multiple levels in the hierarchy below that given level.

44. The computer-implemented method of claim 35, further comprising accessing a table allocated to an object class at a given level below the root object class in the hierarchy for at least a predetermined attribute for an object class at a level in the hierarchy below that given level.

45. The computer-implemented method of claim 44, comprising displaying a representation of the class inheritance hierarchy with the display of attributes for given instance of an object class being grouped according to the table in which the attributes are held.
